(19) United States
(12) Patent Application Publication
(10) Pub. No.: US 2007/0251781 A1
(43) Pub. Date: Nov. 1, 2007

(54) REMOTE DRAIN VALVE DEVICE FOR AN AIR BRAKE VEHICLE

(75) Inventor: James A. Thomas, Spencerville, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 11/380,670

(22) Filed: Apr. 28, 2006

(51) Int. Cl. B60T 11/34

(52) U.S. Cl. 188/352; 303/85

(57) ABSTRACT

The invention is a remote drain device for purging moisture from an air braking system of a motor vehicle, especially buses and medium and heavy duty trucks. The remote drain device uses purge valves connected with drain tubing to the drain ports of the air braking system air tanks. The remote drain device is located in an easily accessible location, such as the steps, chassis or body of the motor vehicle.

### BACKGROUND OF THE INVENTION

1. Field of the Invention

The present invention relates to a remote drain valve device to purge moisture from air brake systems in motor vehicles, such as medium or heavy duty trucks and buses.

2. Description of the Prior Art

A common form of braking system in motor vehicles, such as medium and heavy duty trucks and buses, uses air pressure. The vehicle engine operates an air compressor to provide the pressure for the braking system. The air pressure is stored in an air tank located within the vehicle to provide a constant pressurized air supply.

The air compressor pulls air from the atmosphere and compresses the air. Because atmospheric air contains moisture, upon compression the moisture condenses. Throughout the continued use of the pressure system, the moisture builds up in the form of a liquid in the air tank.

The continued presence of moisture in the air brake system can harm the braking system and can lead to brake failure. The moisture, for example, can cause deterioration of rubber seals and the like. Additionally, in cold weather, where the moisture has migrated into the pressure lines and other aspects of the braking system, it can freeze causing malfunction or total failure of the braking system.

Accumulated moisture must therefore be drained from the tank before the moisture can flow into the remainder of the braking system. A conventional means for removing moisture from the braking system and, more particularly, from the air tank uses a separate “wet” tank positioned adjacent to the dry air tank and interconnected with the dry air tank by means of a check valve. This wet tank, collects the liquid or moisture in a manner well known in the art.

During normal operation, the wet tank, which has a drain valve in the bottom thereof, operates with the drain valve closed thereby allowing moisture to accumulate therein. Periodically and usually at the end of every day when the vehicle is shut down, the drain valve on the wet tank is manually opened. The check valve between the air tank and wet tank will then go into a closed position and the moisture which has accumulated in the wet tank, by means of the pressure already present therein, will blow the moisture out of the wet tank and purge the system. The other air tanks can be similarly purged to remove any accumulated moisture.

This system for draining of moisture from the air braking system of a vehicle, if operated properly, is effective. One of the severe drawbacks of such a system, however, is that the operators of the vehicle forget to drain the wet tank. After a period of time, the wet tank will fill and the moisture will enter the “dry” air tanks and ultimately the remainder of the braking system with grave consequences.

Current air brake motor vehicles, especially buses, but also including other vehicles with bodies, such as medium and heavy duty trucks, often place air tanks in a position that is very difficult to reach in order to drain the air tanks via the installed drain valves, such as on the chassis. This requires the driver to stoop, contort the body or even crawl on the ground to reach the drain valve. Because daily purging of the air tanks is a U.S. Department of Transportation requirement, it is important to the driver that the drain valves be easily accessible to increase compliance.

The standard drain valve is a petcock drain valve mounted directly to the air tank. This drain valve requires the driver to reach or even crawl under the vehicle to access the drain valve at the end of each of air tank in the air brake system at the end of a work day.

To avoid the inconvenience of crawling around the ground to purge the air tanks, different types of drain valves have been used. Automatic drain valves, for example, operate on a difference in air pressure. These automatic drain valves purge when the air compressor recharges the air system.

Other types of automatic drain valves activate every time the electrical signal to operate the brake lights is used. With this drain valve, the tank purges every time the brakes are applied. This system removes only a very small amount of moisture each time that it is activated and is more easily worn out since it is activated so frequently. Furthermore, should a defect occur in this device, the entire braking system of the truck can be jeopardized.

Remote drain valves in current use are very expensive. These drain valves allow the driver to drain the tanks from the driver's seat by activating the purge mechanism from the dash board. Other remote drain valves use a pull-cord or cable attached to the drain valve. The cable is mounted somewhere more accessible, so that the drain valve opens to purge the tanks when the driver pulls the pull-cord or cable. These pull-cords, however, tend to lock up or fray with frequent use.

Therefore, it would be advantages to produce a system to purge the air tanks that can be done remotely and economically. This system should be easily accessed by the user and durable with use. It should also easily adapt to air braking systems currently in use.

### SUMMARY OF THE INVENTION

According to the invention, there is provided a remote drain device using a purge valve to purge moisture from an air tank. The remote drain device can be mounted on the side of the vehicle or at a common bulkhead connection point, where the purge valves are accessed as easily as filling the fuel tank. When the purge valves are open, the remote drain device is in fluid communication with the air tanks. Because the air in the air tanks is under pressure, opening the remote drain device's purge valves purges air from the air tanks and the moisture within the air tanks and the tubing.

The remote drain device of the invention has a body with a first side of the body having a first opening and an opposite second side of the body having a second opening. A passageway in the body extends from the first opening to the second opening. The purge valve is located at least partially inserted into the first opening and matingly engages at least part of the passageway.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a perspective view of a motor vehicle with the remote drain device of the invention;

FIG. 2 is a block diagram of one embodiment of the invention showing the air purging apparatus and the braking system;

FIG. 3 is a partial perspective view of the air tanks and remote drain device of the invention installed in the motor vehicle;

FIG. 4 partial side view of the remote drain device of the invention installed in the motor vehicle; and

FIG. 5 is a partial top view of the remote drain device of the invention installed in the motor vehicle with the fastener and passageways in phantom.

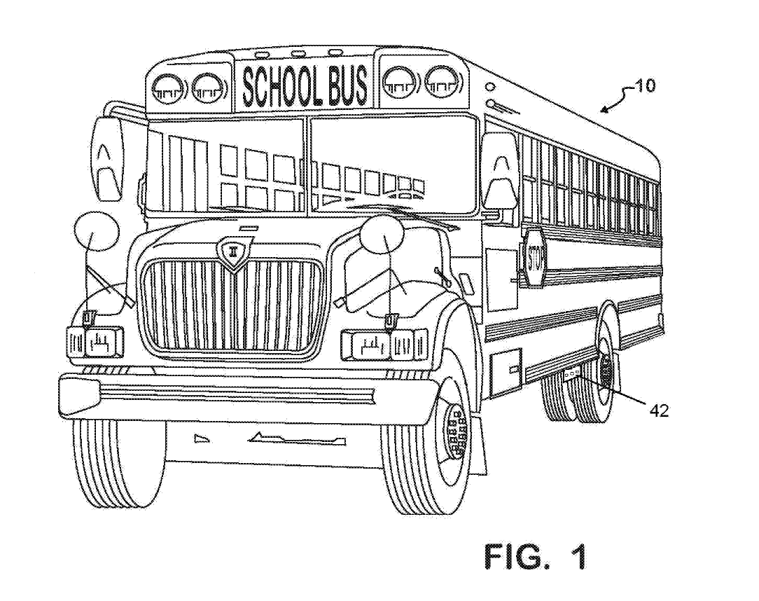

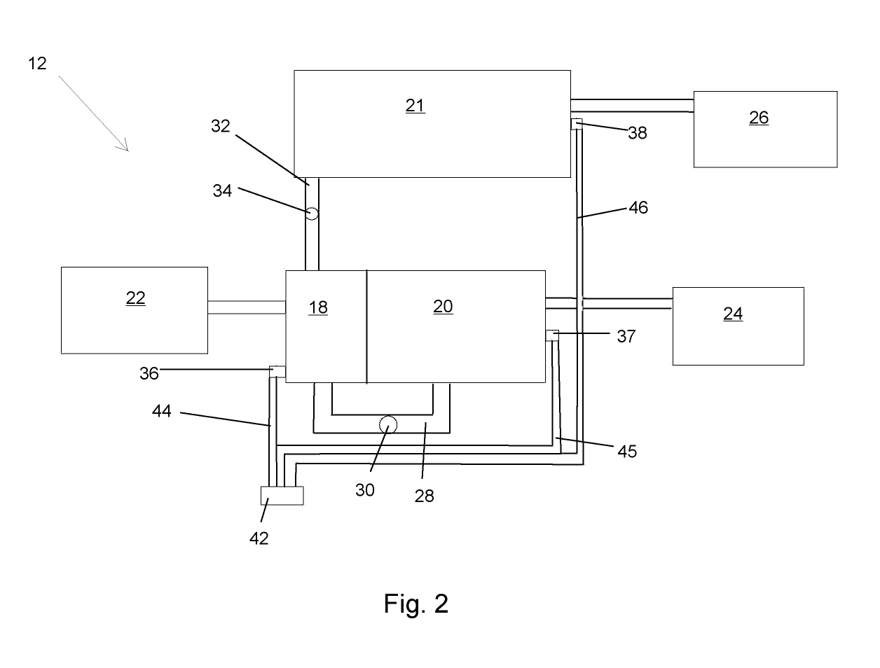

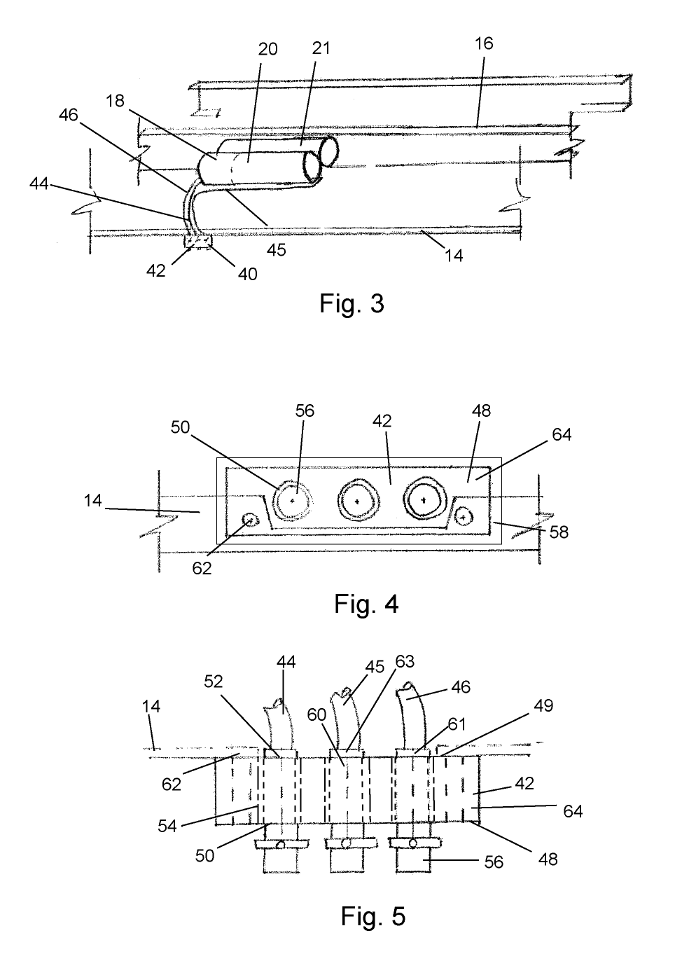

### DETAILED DESCRIPTION OF THE INVENTION

Turning to the Figures, where like reference numerals refer to like structures, a remote drain device 42 is incorporated into an air brake system 12 of a motor vehicle 10, such as medium or heavy duty trucks and buses. The remote drain device 42 mounts with fasteners 62 to an easily accessible location on the motor vehicle, such as the steps, chassis or body where the remote drain device can extend through the outer skin 14 of the motor vehicle. The remote drain device 42 is in fluid communication with the air tanks 18, 20, 21 and the outside air when open. A flange 58 around the perimeter of the remote drain device 42, such as a rollover flange, can be used to seal the outer skin 14. The air tanks are supported by the chassis side rails 16 of the motor vehicle 10.

The air brake system 12 has an air compressor 22 in fluid communication with a wet air tank 18. The wet air tank 18 connects to a secondary air tank 20 and primary air tank 21 with air tubing 28, 32. Check valves 30, 34 may be used to control the flow of air from the wet air tank 18 to the other air tanks 20, 21. Each air tank 18, 20, 21 has a drain port 36, 37, 38. Drain tubing 44, 45, 46 connects each drain port 36, 37, 38 to the remote drain device 42. The secondary air tank 20 connects to the front brake 24. The primary air tank 21 connects to rear brake 26.

The remote drain device 42 typically has a block-shaped body 64 having a first side 48 with a first opening 50 and an opposite second side 49 with a second opening 52. A passageway 54 extends from the first opening 48 to the second opening 49. A purge valve 56 inserts within the first opening and matingly engages at least part of the passageway 54. The passageway 54 and the exterior of the stem 60 of the purge valve 56 can thread together for easy insertion. If desired, the stem 60 of the purge valve 56 can extend through the passageway 54 and exit through the second opening 49.

The drain tubing 44 engages the remote drain device 42 using a tubing connector 61 and is in fluid communication with the purge valve 56. The tubing connector 61 preferably connects to the stem 60 of the purge valve 56 using a quick-connect collet-style tubing connector 63 attached to the drain tubing 44 to allow the quick and easy connection of the purge valve 56 and drain tubing 44.

Multiple drain tubing can be used to drain all the tanks of the air brake system. Additional drain tubing 45, 46 are each in fluid communication with additional purge valves 56 engaging additional passageways 54 extending from one of the first openings 50 in the first side 48 of the body 64 to the one of the second openings 52 in the second side 49 of the remote drain device 42. Drain tubing 45, 46, for example, attach to tubing connectors 61. Each tubing connector 61 in turn attaches to one of the purge valves 56 in one of the passageways 54.

Purge valves 56 can be any type of valve, although petcock style valves which mount with a common pipe thread are preferred. Using the petcock style valve allows the easy replacement of a damaged or defective purge valve without replacing the entire remote drain device. Alternatively, the remote drain device could incorporate the valves, and the entire remote drain device could be replaced when a purge valve was damaged or defective.

The remote drain device 42 can be used with already existing motor vehicles. The remote drain device can be fastened with fasteners to the steps of the motor vehicle with the drain tubing connecting to the drain ports. The remote drain device 42 can also fasten to the outer skin 14 of the motor vehicle 10. A hole, for example, can be cut within the outer skin 14 to fit the remote drain device. Drain tubing attached to the drain ports of the air tanks can be extended to the hole. Then, the purge valves could be attached to the drain tubing. After attaching the drain tubing, the remote drain device could drop fit within the cut hole, fastened with fasteners 62 to the outer skin 14 and the rollover flange used to seal the hole. Alternatively, a smaller hole can be cut to fit the drain tubing with the remote drain device sealing the hole.

The remote drain device 42 is preferably located near the location of and downhill from the air tanks 18, 20, 21. The drain tubing 44, 45, 46 can also be wrapped or packaged with a heater, such as a length of resistance wire or other type of heater to provide an anti-freeze characteristic to the remote air brake purging apparatus 40.

The remote drain device of the invention allows the use of the current design in air braking system for motor vehicles while replacing the inconvenient access to the drain valves. The driver can easily reach the remote draining device to open the purge valves to purge the air braking system, then close the purge valves. Since a motor vehicle driven daily throughout the work week is expected to be drained approximately 200 times per year, this is an important feature.

The air tank drain valves are easily accessible, regardless of air tank location relative to body or chassis components.

While the invention is shown in only one of its forms, it is not thus limited but is susceptible to various changes and modifications without departing from the spirit and scope of the invention.

What is claimed is:

1. A remote drain device for an air braking system of a motor vehicle, comprising:
a body;
a first side of the body having a first opening;
an opposite second side of the body having a second opening;
a passageway in the body extending from the first opening to the second opening; and
a purge valve being at least partially inserted into the first opening and matingly engaging at least part of the passageway.

2. A remote drain device for an air braking system of a motor vehicle of claim 1, wherein the purge valve further comprises:
a stem within the passageway extending from the first opening to the second opening.

3. A remote drain device for an air braking system of a motor vehicle of claim 2, wherein the stem of the purge valve and the passageway thread together.

4. A remote drain device for an air braking system of a motor vehicle of claim 3, further comprising:
a tubing connector connecting to the stem of the purge valve.

5. A remote drain device for an air braking system of a motor vehicle, comprising:
a body;
a first side of the body having first openings;
an opposite second side of the body having second openings;
passageways in the body, each passageway extending from one of the first openings to one of the second openings; and
purge valves, each purge valve being at least partially inserted into one of the first openings and matingly engaging at least part of one of the passageways.

6. A remote drain device for an air braking system of a motor vehicle of claim 5, wherein the purge valve further comprises:
a stem within the passageway extending from the first opening to the second opening.

7. A remote drain device for an air braking system of a motor vehicle of claim 6, wherein the stem of the purge valve and the passageway thread together.

8. A remote drain device for an air braking system of a motor vehicle of claim 7, further comprising:
a tubing connector connecting to the stem of the purge valve.

9. A remote air brake purging apparatus for a motor vehicle having an air brake system, and an outer skin, comprising:
an air compressor;
an air brake;
an air tank in fluid communication with the air compressor and the air brake;
a remote drain device having a body, a first side of the body having a first opening, an opposite second side of the body having a second opening, a passageway in the body extending from the first opening to the second opening, and a purge valve being at least partially inserted into the first opening and matingly engaging at least part of the passageway; and
tubing in fluid communication with the air tank and the remote drain valve device.

10. A remote air brake purging apparatus for a motor vehicle having an air brake system, and an outer skin of claim 9, wherein the purge valve further comprises:
a stem within the passageway extending from the first opening to the second opening.

11. A remote air brake purging apparatus for a motor vehicle having an air brake system, and an outer skin of claim 10, wherein the stem of the purge valve and the passageway thread together.

12. A remote air brake purging apparatus for a motor vehicle having an air brake system, and an outer skin of claim 11, further comprising:
a tubing connector connecting to the stem of the purge valve.

13. A remote air brake purging apparatus for a motor vehicle having an air brake system, and an outer skin of claim 12, further comprising:
a heater engaging the tubing.

14. A remote air brake purging apparatus for a motor vehicle having an air brake system, and an outer skin of claim 12,
wherein the remote drain device attaches to the outer skin of the motor vehicle.

15. A remote air brake purging apparatus for a motor vehicle having an air brake system, and an outer skin of claim 9, further comprising:
additional air tanks; and
wherein the remote drain device has multiple passageways, and each passageway is in fluid communication with one of the air tanks.

16. A remote air brake purging apparatus for a motor vehicle having an air brake system, and an outer skin of claim 15, wherein the purge valve further comprises:
a stem within the passageway extending from the first opening to the second opening.

17. A remote air brake purging apparatus for a motor vehicle having an air brake system, and an outer skin of claim 16, wherein the stem of the purge valve and the passageway thread together.

18. A remote air brake purging apparatus for a motor vehicle having an air brake system, and an outer skin of claim 17, further comprising:
a tubing connector connecting to the stem of the purge valve.

19. A remote air brake purging apparatus for a motor vehicle having an air brake system, and an outer skin of claim 18, further comprising:
a heater engaging the tubing.

20. A remote air brake purging apparatus for a motor vehicle having an air brake system, and an outer skin of claim 18,
wherein the remote drain device attaches to the outer skin of the motor vehicle.
